(19) United States
(12) Patent Application Publication
(10) Pub. No.: US 2008/0306878 A1
(43) Pub. Date: Dec. 11, 2008

(54) METHOD AND SYSTEM FOR ADMINISTERING INDEX-LINKED ANNUITY

(76) Inventors: Charles Phillip Elam, II, Greensboro, NC (US); Shuang Chen, Greensboro, NC (US)

Correspondence Address: BARNES & THORNBURG LLP, 600 ONE SUMMIT SQUARE, FORT WAYNE, IN, 46802, US

(21) Appl. No.: 11/758,486

(22) Filed: Jun. 5, 2007

(51) Int. Cl. G06Q 40/00

(52) U.S. Cl. 705/36 R

(57) ABSTRACT

A method for administering an annuity product comprises the steps of establishing an annuity account, storing data relating to the account, determining an amount of an income payment and paying the income payment to the account owner. The amount of the income payment is subtracted from an account value. The amount of the account value is adjusted by a first process which includes adjusting the account value by a first index. The amount of the income payment is periodically redetermined by a second process which includes adjusting the amount of the income payment by a second index. The first and second processes are separate processes designed to cause the account value and a present value of the income payments to diverge, such that the value of the income payments becomes increasingly greater relative to the account value during a payout phase of the annuity account. One embodiment comprises a computer system for administering the annuity product in accordance with the subject method.

### TECHNICAL FIELD

The present invention relates generally to financial products. More specifically, the present invention relates to annuity products and, more particularly, to products that provide new and different mechanisms for distributing income from an annuity contract.

### BACKGROUND AND SUMMARY

Annuity products are well known. Traditional annuities are designed to provide protection against the risks of longevity. In a traditional annuity, an account owner (or annuitant) exchanges a sum of money for a series of periodic payments. The payments typically last for the lifetime of the annuitant, although annuity contracts may provide for payments for a fixed term of years or other period-certain.

In a traditional annuity, after the account owner has paid the sum, or premium, to an insurance company, the only returns to which the annuitant is entitled are the periodic (e.g., annual, quarterly, monthly) payments. If the annuitant lives long enough, he/she may be paid more than the initial premium, plus interest. The chief advantage of such an annuity is that the annuitant cannot outlive the stream of payments. However, in the event of premature death, the annuitant may “lose” a substantial portion of the original premium.

A disadvantage of traditional annuities is loss of liquidity in the asset which comprises the premium. After establishing the account, the annuitant typically loses all rights in the premium amount, and is entitled only to the periodic payments. In the event of an unanticipated need for cash, the annuitant no longer has access to the assets used to establish the account.

To address these concerns, some annuity products offer a limited death benefit which will pay some portion of the original premium to the estate or heirs of the annuitant at the time of death. Some products also offer a commutation feature which allows an annuitant to surrender the contract for a lump sum before all the periodic payments are made. However, these features may be costly to both the annuitant and to the insurance company in particular cases.

Other disadvantages of traditional annuities are the loss by the annuitant of the ability to direct investment of the assets, and to share in the investment-related growth of the assets. To address such disadvantages, insurers have offered products which allow the annuitant to maintain some control of and access to an underlying account value. One such product offers a guaranteed minimum withdrawal benefit (GMWB). Annuity products which include a GMWB feature allow the account owner to make monthly, quarterly, or annual withdrawals of a certain percentage of the account value. The ability to make such withdrawals may be guaranteed for life. However, the annuitant can withdraw more than the designated percentage if the need arises. The account owner can also direct the investment of the account value, and benefits from the investment growth of the account value. Thus, the account value may increase over time, despite the periodic withdrawals. This may provide a substantial death benefit or cash surrender value to the annuitant.

The assignee of the present application offers GMWB and other annuity product variations having variable annuity income features. These provide lifetime income by applying income factors to an income base or account value. Income payments may go up and down in accordance with the investment performance of the account value. Changes to future income payments are based on the actual performance of the account value, resulting in changes in the income base, changes in the income factor, or variances between actual investment results in the Assumed Interest Rate (AIR). Insurance companies may provide additional guarantees that affect the income benefit, including roll up, periodic step-up of income base to account value, and/or minimum payments.

A key feature of such prior designs is that changes in future income benefits are determined and driven by actual account value performance, subject to any additional guarantees provided by the insurer. Thus, the access benefit and the death benefit, which are directly related to the account value, are closely related to the income benefit. In most cases, changes in the account value drive changes in the income benefit. In some products, the payments will be adjusted annually so that the value of future income benefits is always approximately equal to the current account value. For GMWB products, future income payments are adjusted by predefined formulae based on actual account value performance, subject to guarantees provided by the company. The resulting future income benefit could have a higher or lower value than the account value, depending upon the particular realized account performance. However, in both cases, the income benefit and the account value are related.

A traditional annuity product provides an income benefit, but does not provide an access or death benefit, or provides only a limited access value or death benefit. For example, a traditional “life only” single premium immediate annuity (SPIA) does not offer any liquidity or death benefit. Some SPIA riders allow the policy holder to commute period-certain payments or, in some cases, life contingent payments under limited conditions, or with an interest rate adjustment. However, providing liquidity with a SPIA subjects the insurer to disintermediation risks and mortality anti-selection risks. Policy holders will have an incentive to surrender the policy when new money rates are high, forcing the insurer to sell assets at a loss. Policy holders in bad health will be more likely to opt for early surrender, as opposed to taking income benefit payments over their remaining lifetime.

The insurer can limit these risks through product design. For example, disintermediation risk can be mitigated by imposing a market value adjustment on unscheduled payments. Mortality anti-selection can be addressed by requiring underwriting when policy holders request access to the lump sum cash benefit. In each of these cases, the access value is generally closely related to the income benefit. Indeed, the access value often represents a commuted value of the remaining future guaranteed or non-guaranteed income payments, based on the annuitants' then-current life expectancy and the current interest rate environment. Although such design features may be employed by the insurer to limit disintermediation and anti-selection risks, they can be cumbersome and expensive to administer.

Unlike prior product designs, the product design of the present invention intentionally separates the lifetime income benefit from the account value and, thus, the access and death benefits. Such separation is achieved from the outset, i.e., when the policy is issued. The initial payment is established by the insurance company. Subsequent lifetime payments are determined by a process which links the payments to the performance of an outside index, which could be a domestic equity market index such as the S&P 500, an international index such as the MSCI EAFE Index or the Nikkei 225 Index, a commodity index such as the GSCI, the Consumer Price Index (CPI), a fixed interest rate or designated cost of living adjustment, treasury yields, the corporate bond yield index, etc. Before adjusting the income payments by one or the other of these factors, the insurer can make various adjustments to the factor(s), such as by setting a floor, cap or spread, or by averaging. However, the performance of the chosen index, and the associated adjustments thereto, are the only variables that impact subsequent income payments.

Under this invention, adjustments to income payments have no relationship to the actual account value performance. The account value (and, thus, the access/death benefit) is periodically adjusted by a process which is separate and distinct from the process used to determine subsequent income payments. In this separate process, the account value is credited with “interest” and reduced by the income payments. The interest credited to the account value may be linked to the same index or factor used to adjust the income payment, or to a different index or factor. The index or factor may be subject to the same or different adjustments, including floors, caps, spreads, and/or averages. However, an additional design feature of the present invention impacts the choice of indices, factors and/or adjustment mechanisms used in the separate processes for determining income payments and adjusting the account value. In the present invention, the present value of the lifetime income payments and the current account value diverge after issue, such that the value of the income payments exceeds the account value at all times and by an ever-increasing amount. Thus, if the respective values are equal at the time of policy issue, the process used to determine subsequent income payments is more favorable (i.e., will result in higher income payments) than the separate process used to adjust the account value. This may be achieved by selection of the index, factor and/or adjustment mechanisms used in the respective processes. Alternatively, the initial benefit payment can be set at a higher level than would otherwise be justified by the initial premium payment, and the same index, factor and/or adjustment mechanisms can be used to achieve the desired divergence. In any event, the overall process used to adjust the income benefit payments is never less favorable to the account owner than the process used to adjust the account value.

This design feature will cause the account value to be depleted within some number of years from issue. Income payments will continue after the account value is depleted. Indeed, changes in the associated index will continue to produce changes in the income benefit amounts after the account value is exhausted. This feature increases the likelihood that the account owner will stay in the product regardless of changes in interest rates or other market conditions, and regardless of changes in his/her health and physical well being. Thus, the subject invention addresses many of the problems and shortcomings of currently-available annuity products.

In one embodiment, the present invention comprises a method for administering an annuity product. The method comprises the steps of establishing an annuity account and storing data relating to that account, including data relating to an account owner, an account value (e.g., an initial premium), and at least one index. The method further comprises the steps of determining an amount of a lifetime income payment, which at the outset may be described as an initial payment, and paying the income payment to the account owner. The amount of the income payment is subtracted from the account value, and the account value is adjusted by a first process which includes adjusting the account value by a first index. The amount of the income payment (i.e., the next or subsequent income payment) is redetermined by a second process (which is separate from the first) which includes adjusting the amount of the income payment by a second index. The steps of paying the income payment to the account owner and adjusting the account value and subsequent income payment are periodically repeated (e.g., monthly, quarterly, annually) in the course of administering the annuity product. As noted, the first process used to adjust the account value and the second process used to redetermine the amounts of the periodic income payments are separate processes, such that the adjusted account value and subsequent income benefits are not related (i.e., one is not determined by the other). Moreover, the first and second processes are designed to cause the account value and a present value of the periodic income payments to diverge over time, such that the value of the periodic income payments becomes increasingly greater relative to the account value during the payout phase of the annuity account.

In general, the order or sequence in which the steps of the method are performed is not critical. For example, the account value may be adjusted by the first process before or after (or concurrently with) re-determination of the amount of the income payment by the second process. Storing data relating to the account and paying the income payment to the account owner may also take place at various times. It is not required that income payments be made to the account owner following each determination (or re-determination) of the amount of the income payments. Conversely, multiple payments may be made to the owner during the period between determinations.

In certain embodiments, the method further comprises the step of allowing the account owner to receive an unscheduled payment from the account value. In these embodiments, the amount of a subsequent income payment is adjusted in response to the unscheduled payment. These and other embodiments may also include the step of determining an amount of a minimum guaranteed lifetime income payment. In such embodiments, the step of periodically paying the income payment to the account owner comprises the step of paying the greater of the income payment and the minimum guaranteed income payment to the owner. The amount of the guaranteed minimum payment may be re-determined, either periodically or from time-to-time, in accordance with the annuity contract.

Certain embodiments of the invention may further comprise the step of providing a death benefit to the owner. In some embodiment the death benefit is equal to the account value. These and other embodiments may include the steps of determining a mortality risk charge, and periodically subtracting the mortality risk charge from the account value.

Some embodiments of the invention may further comprise the steps of providing a cash surrender value to the account owner, and periodically determining (or redetermining) an amount of the cash surrender value. In certain embodiments, a surrender charge may be assessed.

The first and second indices used to adjust the account value and income payment, respectively, are designated in the annuity contract, and are preferably selected from a group of published (or publicly available) indices. Examples of such indices include: Standard & Poor's 500, the Goldman Sachs Commodity Index, the Consumer Price Index, a fixed interest rate, an international index, a Corporate Bond Yield Index, and a U.S. Treasury Index. Although the same index may be selected from the group to adjust both the account value and income payment, such is not required and may, in certain circumstances, be undesired. For example, the account value may be indexed (i.e., adjusted) by changes in the Standard & Poor's 500 index, while the income payment may be adjusted by the greater of the Standard & Poor's 500 Index and the Consumer Price Index. One aspect of this and other embodiments of the invention is that such adjustments to income payments are not dependent on actual account value performance. The respective values of the income benefit, on the one hand, and the account value, death benefit and/or cash surrender value on the other hand, are separately determined over the life of the product and account owner. This separation is accomplished by the separate processes and separate indexing of the lifetime income benefit and the account value. Divergence of the value of the income benefit from the account value is ensured by the processes used to determine each value. Such divergence is independent of the performances of the relevant indices and utilization of the access benefits in the account value.

In certain alternative embodiments, either the first or the second indices (or both indices) may be the greater of a plurality of designated indices. For example, if the designated group includes the Consumer Price Index, a fixed interest rate, and a U.S. Treasury index, the first (or second) index may be selected in any given period as the highest one of those designated indices.

In certain embodiments, either or both of the first or second of the indices may be adjusted as part of the respective first and second processes. For example, the first index may be specified as the Consumer Price Index less 1%, while the second index may be specified as the Consumer Price Index plus 1%. In these or other embodiments, minimum and/or maximum values may be established for either or both of the first and second indices. As indicated, a feature of the invention is the divergence over time of the value of the income payments relative to the account value. In order to assure such divergence, the second index used to redetermine income payments will generally be more favorable to the account owner than the first index used to adjust the account value. This assumes that the initial income benefit payment is set using a discount rate which might traditionally be used in an annuity product, and which approximately equates the value of the projected income payments to the value of the initial premium. If instead a higher discount rate is used to set the initial premium, resulting in a higher initial benefit payment, then the same index (or adjusted index) could be used to adjust both income benefit payment and account value. This feature allows the insurance company to offer a higher income benefit payment to the account owner than might otherwise be justified by the initial account value.

In at least certain embodiments, the invention may include the steps of establishing a charge associated with the annuity product. Such embodiments may also include the step of periodically deducting the charge from the account value.

Certain embodiments of the present invention comprise a system for administering an annuity product in accordance with the above described method.

Additional features and advantages of the method and system will become apparent to those skilled in the art upon consideration of the following detailed description of the illustrated embodiment exemplifying the best mode of carrying out the method and system as presently perceived.

### BRIEF DESCRIPTION OF DRAWINGS

The method and system will be described hereafter with reference to the attached drawings which are given as non-limiting examples only, in which:

FIG. 1 is a flow chart illustrating a portion of an embodiment of the present invention.

FIG. 2 is a flow chart illustrating a further portion of the embodiment of FIG. 1.

FIG. 3 is a flow chart further illustrating the embodiment of FIGS. 1 and 2.

FIG. 4 is a flow chart further illustrating the embodiment of FIGS. 1-3.

FIG. 5 is a flow chart further illustrating the embodiment of FIGS. 1-4.

FIG. 6 is a table which illustrates a first detailed example.

FIG. 7 is a table which illustrates a second detailed example.

The descriptions set out herein illustrate exemplary embodiments of the method and system, and such exemplification is not to be construed as limiting the scope of the claims to the details of the descriptions, or in any manner.

### DETAILED DESCRIPTION OF THE DRAWINGS

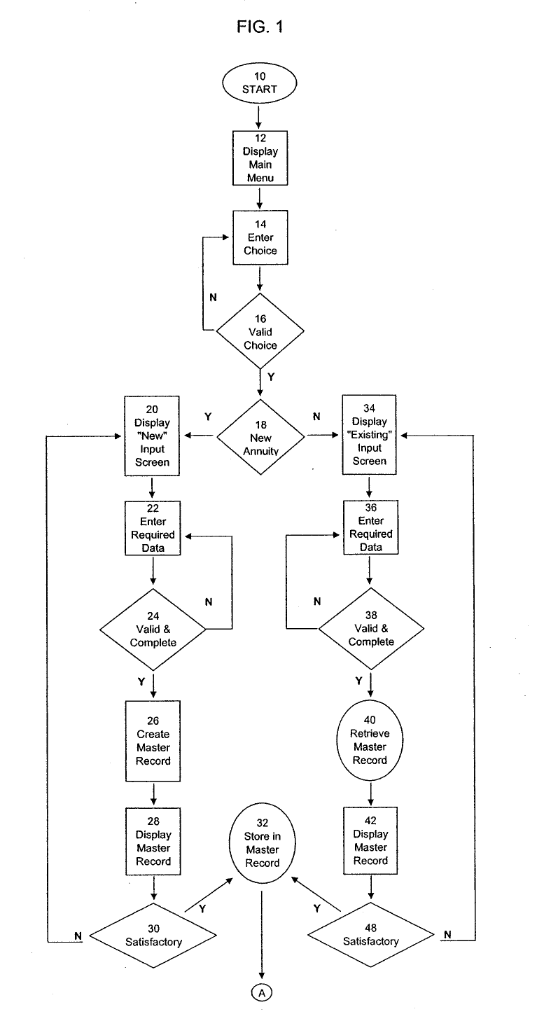

FIG. 1 is a flow chart which illustrates a portion of a computerized method of practicing an embodiment of the present invention. More particularly, FIG. 1 is an illustrative embodiment of steps taken to collect data which is used in the remainder of the embodiment of the process, as described in more detail below. For a new annuity, the data collected through the individual steps illustrated in FIG. 1 may be entered manually at a computer terminal or equivalent input device, or electronically, or in any other manner which is customary at present or in the future. For an existing annuity, the data will generally be retrieved from an existing contract master record, or other file.

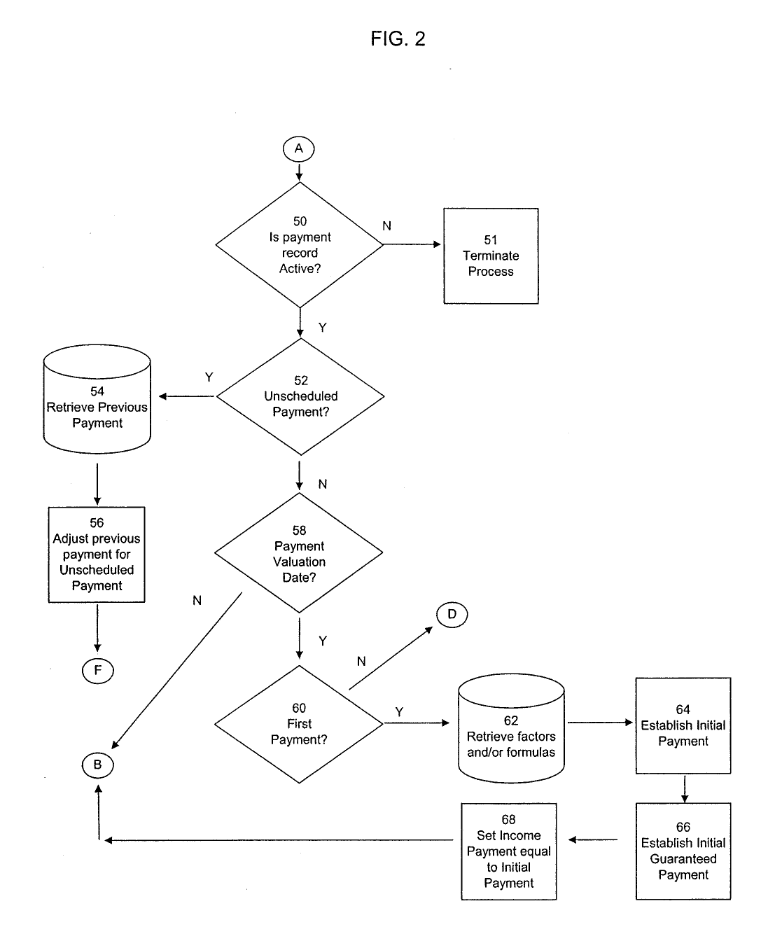

The process may be initiated (block 10) either manually at a work station, or automatically in a batch cycle. In either case, a main menu is displayed (block 12) or provided, offering a number of possible operations. A choice may be entered by an operator or emulator (block 14). The choice may be validated as indicated in FIG. 2 (block 16).

After a valid choice has been selected, the system determines whether the subject annuity is a new annuity or an existing annuity (block 18). For a new annuity, the process proceeds to display a new annuity input screen (block 20). This screen contains entry fields for items such as: information regarding the annuitant, owner and/or beneficiary; information regarding type of annuity chosen, including relevant dates and amounts; information relating to indices; information relating to income and/or mortality guarantees; and other related information. This data is entered (block 22) and checked for validity and completeness (block 24). If the data is valid and complete, a master record is created (block 26). The fields of this master record are populated with the data entered in step 22. The new master record is then displayed (block 28) for visual checking by an operator. If the data is deemed to be satisfactory (block 30), the master record is stored in a master record file (block 32). If the data is not satisfactory, the process repeats as indicated in FIG. 1.

Referring again to step 18, if the system determines that an existing annuity is to be dealt with, processing proceeds to display the existing annuity input screen (block 34). This screen contains entry fields for items such as: contract number; annuitant identification; and other items associated with the existing annuity contract. New data is entered (block 36) via the existing annuity input screen, and such new data is checked to determine validity and completeness (block 38). The master record associated with the existing annuity contract is retrieved (block 40) and displayed (block 42) for viewing by an operator. If and when the master record, as updated by the newly inputted data, is satisfactory (block 48), any updated data is stored in the master record (block 32).

FIGS. 2, 3 and 4 illustrate the next steps in the overall process of this illustrative embodiment. Those steps relate to the initial and periodic determinations and calculations relating to account value, death benefit, cash surrender value, income payments and unscheduled payments. More particularly, the flow charts of FIGS. 2, 3 and 4 further illustrate one embodiment of a computer-based process/system for determining these (and related) quantities.

The system/process illustrated in FIGS. 2, 3 and 4 is intended to be run daily with regard to all active accounts. In the embodiment illustrated, the account value is adjusted daily, as will be described in additional detail below. If the account owner has requested an unscheduled payment, or if the date for an initial or subsequent income payment has arrived, the system will cause such payments to be made, as described below. It should be emphasized once more that the process/system illustrated is intended by way of example and illustration only. Numerous variations are possible and will be apparent to those of skill in the art. However, such variations (such as the frequency of adjustments made to the account value) are intended to be covered by the scope of the appended claims.

With reference to FIG. 2, the system first determines whether a payment record is active for a particular account (block 50). That is, is the account still active, or has the account been discontinued for some reason since the preceding day or preceding business day (i.e., the last run day). An account may become inactive, for example, upon the death of the annuitant. If the payment record is not active, then the process terminates with regard to that account (block 51). If the account is active, the process proceeds as indicated in decision operation 52 to determine whether an unscheduled payment has been requested by the account owner.

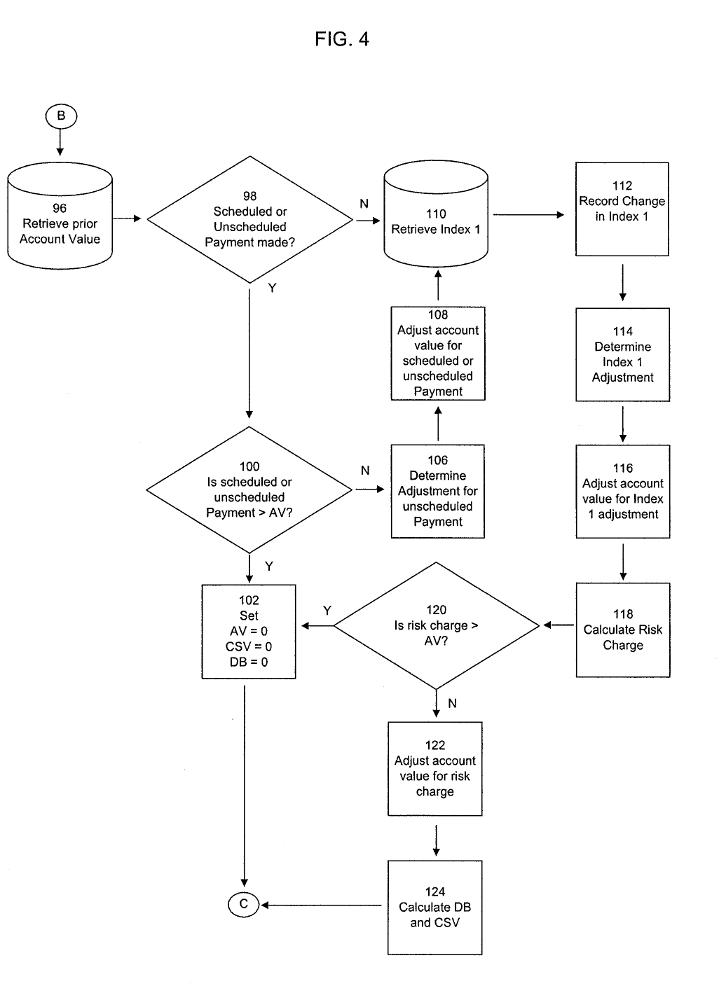

If the payment record is active and the process/system determines in decision operation 52 that the account owner has requested an unscheduled payment, the system proceeds as indicated in FIG. 2 by retrieving previous income payment information (block 54). Since an unscheduled payment will affect the amount of future income payments, an adjustment must be made to the amount of periodic income payments to be made in the future to reflect the impact of the unscheduled payment. This adjustment is illustratively indicated in FIG. 2 by block 56. By way of example only, such adjustment may be made by reducing the income payment proportionately based on the proportion of the account value taken as an unscheduled payment. Following the unscheduled payment, income payments would continue to be made, but at the reduced level. If the entire account value is withdrawn, the income payment would be reduced to zero, and no further income payments would be made. Other mechanisms for making the subject adjustment to the income payments may be used. The process then proceeds as indicated to the flow chart of FIG. 4.

If the subject disbursement is not an unscheduled payment, the system/process checks the payment valuation date to determine whether the payment valuation date (i.e., the date on which an initial or periodic income payment is to be made) has arrived (block 58). If not, the system proceeds as indicated in FIG. 4. If yes, the process determines whether the subject income payment is the first or initial payment to be made under the contract (block 60). If yes, the factors and/or formulae necessary to determine the amount of the first payment are retrieved (block 62) and the amount of the initial payment is established (block 64). In certain embodiments, the initial payment may be established with the same formula(ae) and factors typically used to calculate an initial payment for known annuity products. As discussed above, in those embodiments a more favorable index is then used to redetermine the amounts of the periodic income payments than that used to adjust the account value. Alternatively, a higher discount rate may be used in the traditional formula(ae) to determine the initial payment, resulting in an initial payment that is higher than would be typical. In that case, a more favorable index may still be used to adjust the income payment, but an equivalent index could also be used. In either event, divergence of the value of the income payments and the account value would be assured. Other combinations of initial income benefit payment and indices may produce an equivalent result, as will be apparent to those of ordinary skill in annuity product design.

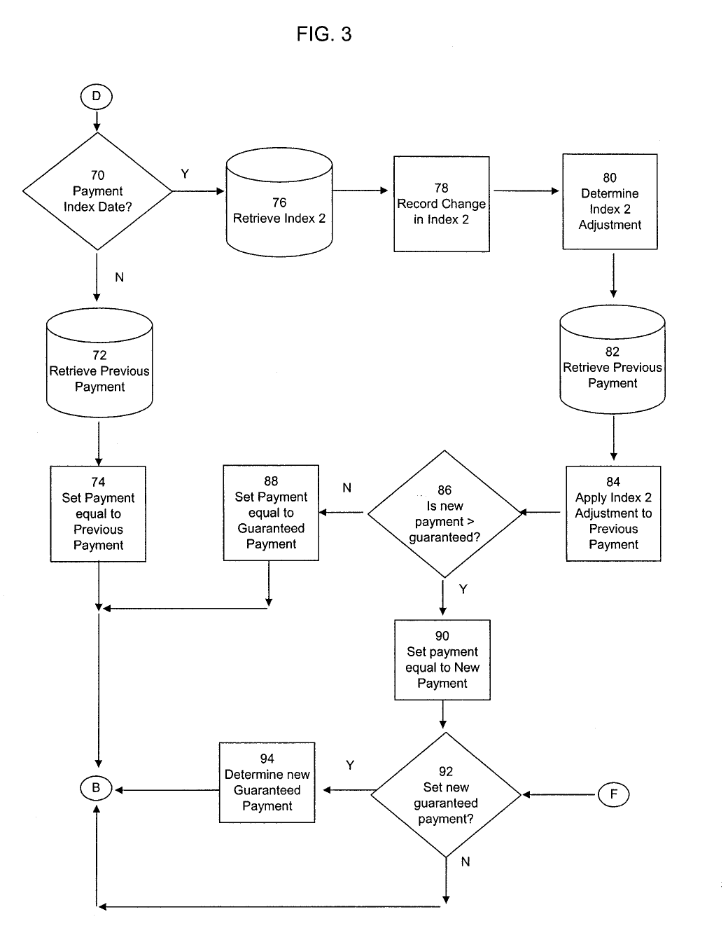

If the subject contract includes a minimum guaranteed initial payment amount, that amount is also established (block 66). The income payment amount is then set equal to the greater of the initial payment or the initial guaranteed payment (block 68). The system and process then proceeds as indicated in the flow chart of FIG. 3.

With reference to FIG. 3, if the system has determined that the subject disbursement is not the initial payment, a decision operation determines whether the payment index date has arrived (block 70). The payment index date may be coincident with the disbursement of a periodic income payment to the account owner. Alternatively, indexing may occur on a different schedule. For example, the amount of the income payment may be indexed monthly, while periodic income payments are disbursed quarterly or annually. If the payment index date has not arrived, the system proceeds to retrieve the previous payment (block 72) and set the amount of the income payment equal to the previous payment (block 74). This situation may occur, for instance, if disbursements in the form of income payments are made quarterly, but adjusted annually. On the payment index date, the system will redetermine the amount of the periodic payment as described below. For the remaining three quarterly payments in that year, the previous payment amount will be used.

If it is the payment index date, the index by which the income payments are adjusted (termed “Index 2” in this embodiment) is retrieved (block 76). The change in Index 2 is then recorded (block 78). If provided for in the contract, an adjustment to Index 2 is determined (block 80). For example, if Index 2 is the CPI, the contract may provide for adjustment of the income benefit by the change in the CPI plus 1%. If the index is the S&P 500, the contract may provide for a cap (or floor) of 6% (or 3%). As will be appreciated, other forms of adjustment may be used.

After adjustments (if any) to Index 2, the amount of the previous payment is then retrieved (block 82) and the adjusted index is used to redetermine the amount of the payment (block 84). The new payment amount is then compared to the guaranteed amount in decision operation 86, if the contract provides this feature. If the new payment amount is less than the guaranteed amount, then the amount is set equal to the guaranteed payment (block 88). If the new payment amount is greater than the guaranteed amount, then the amount is set to equal the new income payment (block 90). If appropriate under the contract (decision operation 92), a new guaranteed payment is also determined (block 94). Following that operation, or if a new guaranteed payment is not determined, the system proceeds as indicated in the flow chart of FIG. 4.

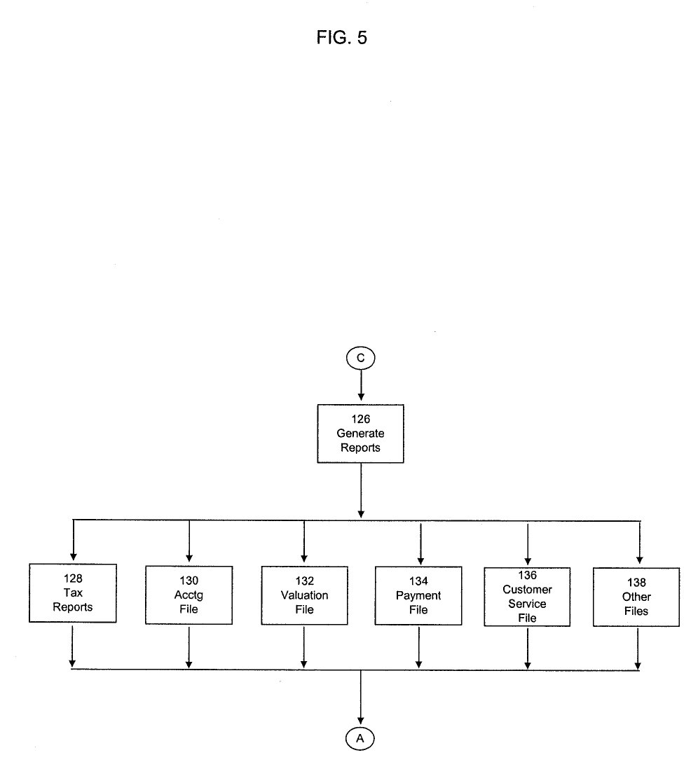

FIG. 4 illustrates the manner in which the account value is adjusted to reflect disbursements, and periodically adjusted in accordance with one or more predetermined indices as provided in the contract. With reference to FIG. 4, this portion of the system and process begins by retrieving the prior account value (block 96). A decision operation then determines whether a scheduled or unscheduled disbursement has been made (block 98). If so, another decision operation determines whether or not the amount of the subject disbursement is greater than the amount of the account value (block 100). If so, the account value, cash surrender value and death benefit are all set to zero (block 102). The process then proceeds to FIG. 5.

If the amount of the disbursement is not greater than the account value, the system/process determines whether an adjustment is appropriate for an unscheduled payment (block 106). The amount of the account value is then adjusted by deducting the amount of the disbursement (scheduled or unscheduled) from the account value (block 108).

Following the operation of block 108, or if decision operation 98 determined that no disbursements are being made, the system/process retrieves the index or indices used to adjust the account value under the contract. In this embodiment, the index is termed Index 1. This operation is represented by block 110. The system then determines and records the change in Index 1 (block 112) and adjusts the index, if appropriate (block 114). Adjustments to Index 1 may include the same types of adjustments (floors, caps, averaging, plus or minus a percentage, etc.) as may be used to adjust Index 2. The adjusted index is then used to adjust the account value as specified in the contract (block 116). In this embodiment, a risk charge is then calculated (block 118) and the system determines in a decision operation whether the risk charge is greater than the account value (block 120). If so, the account value, cash surrender value and death benefit are set to zero and the process proceeds as indicated in FIG. 5. If the risk charge is less than the account value, the account value is adjusted to reflect the risk charge (block 122) and a new death benefit and cash surrender value are calculated (block 124). The system/process then proceeds as indicated in FIG. 5.

With reference to FIG. 5, after the account value, death benefit and cash surrender value are adjusted, the master record file is updated (block 32) and reports are generated (block 126). Such reports may include tax reports (block 128), accounting files (130), valuation files (132), payment files (block 134), customer service files (block 136), and any other necessary files (block 138) relating to the subject account. If appropriate, a check and/or report is generated and forwarded to the account owner. The process and system then returns to the flow chart of FIG. 2 with regard to the next account.

### DETAILED EXAMPLES

Following are examples of specific products which incorporate principles of the present invention. These examples are presented for purposes of illustration only, and to further demonstrate the features and advantages of the present invention. The scope of the invention is not intended to be limited to these examples, and it will be readily apparent to those of skill in the art that variations may be introduced to particular products without departing from the principles set forth herein.

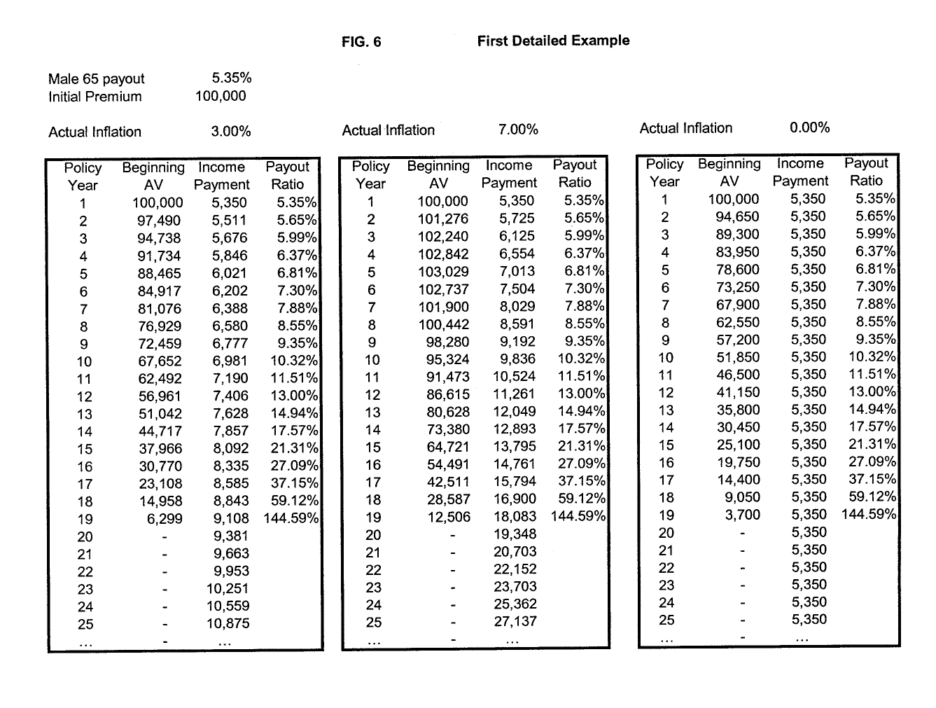

FIG. 6 is a table which illustrates a first detailed example. In this example, the income payment for the first year is determined, and is expressed as a percentage of the annuity premium. This percentage is determined by the offering company, and may vary based upon the age and gender of the policy owner, as well as by other factors. Subsequent income payments are adjusted annually by a percentage which is equal to the change in the Consumer Price Index during that policy year. In this particular example, the account value (which is established by the initial premium and from which income payments are subtracted) is also adjusted annually by the percentage change in the CPI.

The account value is available to the policy owner for additional unscheduled payments. Such payments may, or may not, be subject to surrender charges. An unscheduled payment will reduce both the account value and future income payments. In this example, the account value is also payable as a death benefit upon the death of the annuitant. However, the income payments will continue even after the account value is exhausted for as long as the account owner is alive. The income payment will continue to be adjusted by annual changes in the CPI after the account value is exhausted.

The table of FIG. 6 shows a numerical example in which a policy is issued to a 65 year old male based upon a $100,000.00 initial premium. At issue, the account value is $100,000.00. In this example, the company has set an initial payout ratio (i.e., the amount of an annual payment divided by the account value) of 5.35% for a 65 year old male. Accordingly, the income payment in the first policy year is $5350.00. With reference to the four columns on the left side of FIG. 6, this initial income payment is adjusted annually by the change in the CPI. For purposes of illustration only, the annual change in the CPI is assumed to be 3% for each year. The actual change in the CPI would, of course, be expected to change from year-to-year over the 25 policy years illustrated in FIG. 6.

In this example, the account value is also indexed by a change in CPI. Thus, the account value in policy year two is equal to the initial premium minus the initial income payment, increased by the 3% change in the CPI.

The three “sections” of FIG. 6 illustrate three different inflation scenarios. The first section shows income payments and associated account values, assuming that inflation (CPI) is a flat 3% per year throughout the entire period. Thus, the initial income payment of $5,350.00 grows by 3% annually, and is equal to $6,981.00 at the end of year 10. The associated account value at the beginning of year 11 is $62,492.00. As illustrated, the account value will be exhausted in year 19. However, assuming the policy holder is still alive, income payments will continue, as will the annual adjustments for inflation.

The other two sections of FIG. 6 illustrate income payments and account values under differing inflation scenarios. The middle section assumes a 7% annual inflation rate. The right section assumes a zero % inflation rate. This particular product achieves separation of the income benefit from the account value (and, thus, the cash value and death benefits). In this example, the only variable which impacts the subsequent lifetime income payments is the change in the CPI. Thus, the value of the cash surrender and death benefits (which depend on the account value) and the lifetime income payments diverge after issue. Divergence is insured in this embodiment, even though both account value and income benefit payment are indexed by the CPI, by using a higher discount rate to set the initial payment (i.e., $5,350.00) than the rate credited to the account value. That divergence is made possible by, and achieved through, the separation of the basis for determining income payments from the basis for determining account values and related death benefits and cash surrender values.

Under this strategy, the difference between the values of the two benefits is guaranteed to increase over time, regardless of the actual performance of the index. To illustrate this feature, a variable “payout ratio” may be calculated as the ratio of annual dollar income payment to the beginning account value in that policy year. The ratio can be considered a proxy for the relative values of the lifetime income payment and the cash surrender/death benefits which are linked to the account value. As indicated in the table of FIG. 6, the payout ratio is 5.35% in policy year 1. The ratio increases every year, and in the 11^{th} year is 11.51%. The income payment for that year is $7,190.00 and the account value is $62,492.00. The ratio of 11.51% indicates that the policy holder is essentially guaranteed a lifetime income benefit of 11.51% of the account value, plus adjustments for future inflation starting in year 11. The 11.51% ratio is significantly higher than the 5.35% ratio in policy year 1, and is significantly higher than could be expected if one were purchasing an annuity in that year with an initial premium of $62,492.00.

This increase in payout ratio is more than can be explained solely by the passage of 10 years. It is an inherent feature of the product design which serves to make the lifetime income benefit superior to the cash value/death benefit over time. Under most market conditions, it would be difficult, if not impossible, for the policy holder to justify a switch to a new product with a current account value that provides an 11.51% lifetime income benefit, indexed to account for inflation and providing both liquidity and a death benefit. Due to the separation of the processes for indexing the income benefit and the account value, the account value is not large enough to generate a comparable lifetime income benefit in an alternative product as the policy ages. Accordingly, the account owner will be much better off (and more likely to stay with the issuing company) by continuing to receive the lifetime income benefit.

With reference to FIG. 6, the same significant increase in payout ratio is seen in the center and right sections of the table which illustrate inflation rates of 7% and zero percent, respectively. This illustrates the fact that the desired outcome is achieved, regardless of the performance of the index. This contrasts with currently available GMWB products where a policy holder may find that he or she would be better off at some point to take the available cash value benefit and switch to a new product.

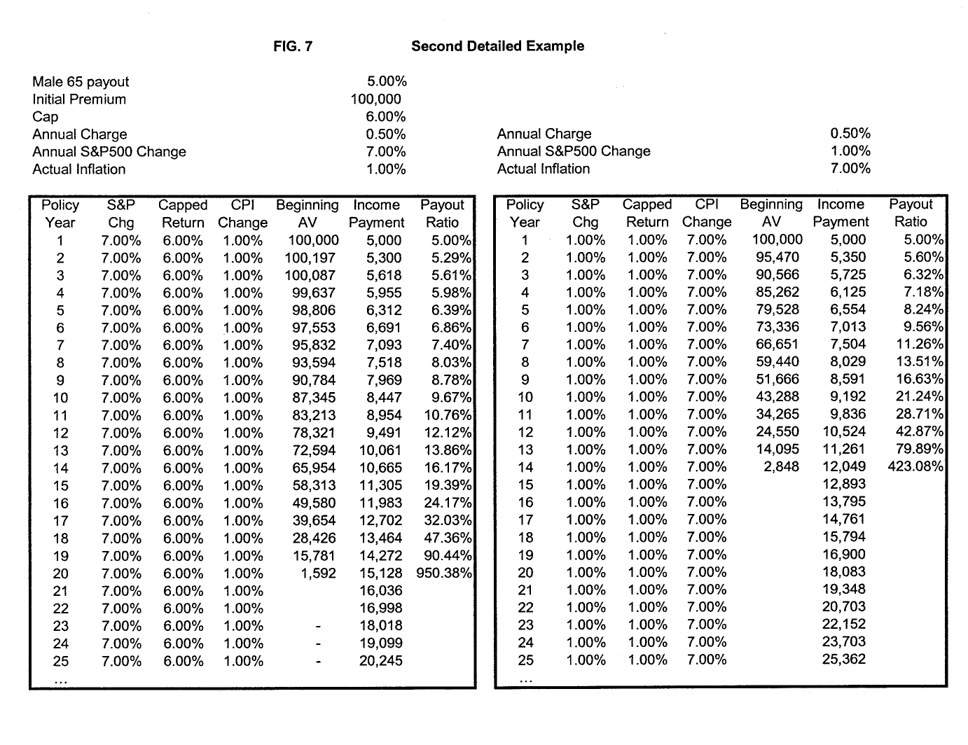

The tables of FIG. 7 illustrate a second detailed example of a product which incorporates the principles of the present invention. In this example, which is also based on an initial premium of $100,000.00, the initial income payment is set at $5,000.00. Subsequent income payments are adjusted at each policy anniversary by a percentage which is equal to the greater of the change in CPI and the change in the S&P 500 capped at 6% during a given policy year. The account value, on the other hand, is adjusted only by the change in the S&P 500, also capped at 6% for a given year. However, the account value is also reduced annually by a charge (in this illustration 0.5%) at the end of the policy year. As in the prior example, the account value is also reduced by the income payments made to the account owner.

As in the prior example, the account value is available for additional unscheduled payments, subject to appropriate surrender charges. An unscheduled payment will reduce future income payments. The account value is also payable as a death benefit upon the death of the annuitant. The lifetime income payments continue even after the account value is exhausted. The income payments will continue to be adjusted by the greater of annual changes in the CPI and the capped S&P 500 after the account value is exhausted.

With reference to the left section of the table of FIG. 7, the annual S&P 500 change is assumed to be 7%, while the change in CPI is assumed to be 1% each year. As indicated, the account value is exhausted at the end of year 20. As with the first examples, the payout ratio increases with each passing year. This is also true in the illustration on the right side of the table of FIG. 7 which assumes annual S&P 500 change of 1% and annual CPI change of 7%.

This example differs from the first in at least two respects. First, the account value and the income payments are indexed to different indices in this example, whereas both account value and income payment are linked to the same index in the previous example. Second, there is an explicit annual charge deducted from the account value in this example, whereas the previous example does not deduct an explicit charge. In both examples, however, the separation of the processes for determining the income benefit on the one hand, and the account value (cash value/death benefit) on the other hand produces the same divergence in the respective values of these benefits as was achieved in the first example. In the example of FIG. 7, divergence is assured by the relatively favorable treatment of the income benefit, which is adjusted by the greater of the change in CPI and S&P 500, while the account value is adjusted only by the change in the S&P 500. Moreover, an explicit charge is deducted annually from the account value. Thus, the product offers a more favorable lifetime income benefit than accumulation benefit over the life of the product. In both examples, the differences between the two benefits are guaranteed to increase over time, regardless of the actual performances of the chosen indices.

Divergence of the respective values of the income benefit and account value can be achieved in several ways. For example, if both account value and income payment are linked to the same index, the initial income benefit is established at a higher level (i.e., using the higher discount rate) than might otherwise be justified. For example, if the chosen index is a fixed rate, such as 3%, the initial income benefit is determined using a 5% discount rate. If the chosen index is the CPI, the initial income benefit is determined with a rate of 2% plus CPI.

In another instance in which both account value and income benefit are linked to the same income, the adjustment to the change of index applied to the income benefit is established to be more favorable than the adjustment to the change of index applied to the account value. For instance, the account value may be adjusted by the lesser of the inflation rate minus 1% and 10%, while the income benefit is adjusted by the lesser of the inflation rate and 10%.

To generalize, the initial income benefit may be established more favorably, and then both income benefit and account value indexed in a manner that treats the income benefit no less favorably than account value, or the initial income benefit may be established as in a traditional annuity, and then indexed more favorably than the account value. In either case, divergence of the respective values of the income benefit and account value over the lifetime of the account owner is assured.

Throughout this specification, and in the following claims, the term “payment” is used, for example, in connection with an income payment, a periodic “scheduled” payment, an “unscheduled” payment, minimum guaranteed income payment, etc. The term “payment” is intended to be broadly construed. A product designed in accordance with the principles of the invention may, for instance, characterize an unscheduled payment as a “withdrawal,” or in some other manner. The term payment as used herein is specifically intended to cover such instance. In short, the term “payment” is intended to refer to any distribution of funds to the account owner, regardless of how characterized or labeled.

Although the above description refers to particular means, materials and embodiments, one skilled in the art can easily ascertain the essential characteristics of the present invention. Various changes and modifications may be made to adapt to various uses and characteristics without departing from the spirit and scope of the present invention as set forth in the following claims.

What is claimed is:

1. A method for administering an annuity product, comprising the steps of:
a. establishing an annuity account;
b. storing data relating to the annuity account, including data relating to an account owner, an account value, and at least one index;
c. determining an amount of an income payment;
d. paying the income payment to the account owner and subtracting the amount of the income payment from the account value;
e. adjusting the account value by a first process which includes adjusting the account value by a first index;
f. re-determining the amount of the income payment by a second process which includes adjusting the amount of the income payment by a second index;
g. periodically repeating steps d, e and f;
h. wherein said first and second processes are separate processes designed to cause the account value and a present value of the periodic income payments to diverge, such that the value of the periodic income payments becomes increasingly greater relative to the account value during a payout phase of the annuity account.

2. The method of claim 1, further comprising the steps of:
allowing the account owner to receive an unscheduled payment from the account value; and
adjusting the amount of the income payment in response to the unscheduled payment.

3. The method of claim 1, further comprising the step of:
determining an amount of a minimum guaranteed income payment; and
wherein, the step of periodically paying the income payment to the account owner comprises periodically paying the greater of the income payment and the minimum guaranteed income payment to the account owner.

4. The method of claim 3, further comprising the step of re-determining the amount of the minimum guaranteed income payment.

5. The method of claim 1, further comprising the step of providing a death benefit to the account owner.

6. The method of claim 5, wherein the death benefit is equal to the account value.

7. The method of claim 5, further comprising the steps of:
determining a mortality risk charge; and
periodically subtracting the mortality risk charge from the account value.

8. The method of claim 1, further comprising the steps of:
providing a cash surrender value to the account owner; and
periodically determining an amount of the cash surrender value.

9. The method of claim 1, wherein the first index is selected from a group which consists of the Standard & Poor's 500, the Goldman Sachs Commodity Index, the Consumer Price Index, a fixed interest rate, a Corporate Bond Yield Index, and a U.S. Treasury Index.

10. The method of claim 1, wherein the second index is selected from a group which consists of the Standard & Poor's 500, the Goldman Sachs Commodity Index, the Consumer Price Index, a fixed interest rate, a Corporate Bond Yield Index, and a U.S. Treasury Index.

11. The method of claim 1, wherein the first index and the second index are the same.

12. The method of claim 1, wherein the first index is the greater of a plurality of designated indices.

13. The method of claim 1, wherein the second index is the greater of a plurality of designated indices.

14. The method of claim 1, wherein at least one of said first and second indices is adjusted as part of at least one of said first and second processes.

15. The method of claim 1, further comprising the step of establishing at least one of a minimum value and a maximum value of the first index.

16. The method of claim 1, further comprising the step of establishing at least one of a minimum value and a maximum value of the second index.

17. The method of claim 1, further comprising the steps of:
establishing a charge associated with the annuity product; and
periodically deducting the charge from the account value.

18. The method of claim 1, further comprising the step of periodically reporting the account value to the account owner.

19. A data processing system for administering an annuity product, comprising:
a. a memory for storing data relating to an annuity account, including data relating to an account owner, an account value, and at least one index;
b. means for determining an amount of an income payment;
c. means for paying the income payment to the account owner and subtracting the amount of the income payment from the account value;
d. means for adjusting the account value by a first process which includes adjusting the account value by a first index; and
f. means for re-determining the amount of the income payment by a second process which includes adjusting the amount of the income payment by the second index;
wherein said first and second processes are separate processes designed to cause the account value and a present value of the periodic income payments to diverge, such that the value of the periodic income payments becomes increasingly greater relative to the account value during a payout phase of the annuity account.

20. The system of claim 19, further comprising means for providing an unscheduled payment to the account owner, and for adjusting the amount of the income payment in response to the unscheduled payment.
